(19) United States
(12) Patent Application Publication
(10) Pub. No.: US 2002/0068604 A1
(43) Pub. Date: Jun. 6, 2002

(54) Wearable data device for use in a wearable data network

(76) Inventors: Samuel Muthiah Prabhakar, Rochester, MN (US); Bryan Lester Striemer, Zumbrota, MN (US); Luis Valdez JR., Rochester, MN (US); George Willard Van Leeuwen, Rochester, MN (US)

Correspondence Address: Steven W. Roth, IBM Corporation, Dept. 917, 3605 Highway 52 North, Rochester, MN, 55901-7829, US

(21) Appl. No.: 09/728,977

(22) Filed: Dec. 4, 2000

(51) Int. Cl. G06F 1/00; H04M 1/00; H04B 1/38

(52) U.S. Cl. 455/556; 708/100

(57) ABSTRACT

A wearable data network is disclosed. The wearable data network a universal data warehouse (UDW) and at least one purpose optimized device (POD). The UDW is carried by the user and is, essentially, a personal data warehouse to store data having a variety of different types and uses (e.g., personal financial data, audio and video files, and presentation files). The UDW, however, is incapable of processing the user's data. Instead, one PODs are used in conjunction with one or more UDWs to process the user's data. As is suggested by its name, a POD is a device that has been optimized to carry out a specific purpose. One example, is a POD that is designed to play the user's audio files, another example is a POD that is designed to render the user's video files, and yet another example is a POD that is designed to render the user's presentation files.

### FIELD OF THE INVENTION

The present invention relates to data processing systems. More particularly, the present invention relates to computer miniaturization and its application to mobile computing.

### BACKGROUND OF THWE INVENTION

In one form or another, different types of computing devices have been in existence for many many years. As time has past, the use of computing devices has become more and more extensive. Very early computing devices were quite large and were primarily used during wartime for performing various mathematical calculations such as deciphering secret codes. In the 1950s and 1960s, the role of computing devices expanded to include business tasks such as payroll and account handling. The 1970s and the 1980s brought the advent of the personal computer, which brought with it the commonplace presence of one or more fully functional computing devices in the home. The Internet and world-wide-web became popular in the 1990s, causing an explosion in the use of all kinds of computing devices, including the very largest server computers and the very smallest types of personal computing devices such as personal digital assistants and cellular phones. The technology associated with this patent involves small personal computing devices.

As mentioned, personal digital assistants and cellular phones are both examples of popular personal computing devices. A fairly recent development in this area has been wearable computing technology. The goal of wearable computing technology involves the miniaturization of computer system components to a point where the components themselves can be worn easily and inconspicuously in much the same way as clothing or jewelry. The problem with current wearable computer technology, however, is that it amounts to the use of old design concepts in a new computing environment. Said another way, present day wearable computer design involves reducing the size of a fully functional computer system so that it can be worn and operated by a user. As such, the resulting devices involve awkward head mount displays, vest and shoulder harnesses with a tangle of wires, and heavy battery packs. While these physical problems are clearly significant, present day designs are also very conspicuous, making for very self-conscious users.

In view of these problems, a new approach to wearable computer design is needed. Without such a new approach, wearable computer technology will continue to be held back by the use of old design concepts.

### SUMMARY OF THE INVENTION

Accordingly, a principal object of this invention to provide a wearable data network.

It is another object of this invention to provide an enhanced portable data device for use in a wearable data network.

It is still another object of this invention to provide an enhanced purpose optimized device for use in a wearable data network.

These and other objects of the present invention are accomplished by the wearable data network disclosed herein. The wearable data network of the preferred embodiment is comprised of at least one portable data device, called the universal data warehouse (UDW) within this patent, and at least one purpose optimized device (POD). The UDW is carried by the user and is, essentially, a personal data warehouse. The UDW is not limited to the storage of any particular type of data, and thus it can be used in innumerable ways. Storage of personal financial data, audio and video files, presentation files, and personal medical records are but a few examples of the usefulness of the UDW. It should also be noted that the UDW is incapable of processing the user's data, meaning that it is not a wearable computer. Instead, the UDW is a “wearable data” device that is used only as portable storage for the user's data. Consequently, the UDW does not involve a headset or tangled wires, nor does it require a heavy battery pack.

One or more purpose optimized devices (PODs) are used in conjunction with one or more UDWs to process the user's data. As is suggested by the name, a POD is a device that has been optimized to carry out a specific purpose. One example, is a POD that is designed to play the user's audio files, another example is a POD that is designed to render the user's video files, and yet another example is a POD that is designed to render the user's presentation files.

### BRIEF DESCRIPTION OF THE DRAWINGS

FIG. 1 is a block diagram of the wearable data network of the preferred embodiment.

FIG. 2A is a block diagram of the universal data warehouse of the preferred embodiment.

FIG. 2B is a block diagram of the data storage structure used in the preferred embodiment for the universal data warehouse.

FIG. 3 is a block diagram of the purpose optimized device of the preferred embodiment.

FIG. 4A is a flow diagram of the steps used in the preferred embodiment to carry out the function of the service discovery handler of the purpose optimized device of the preferred embodiment.

FIG. 4B is a flow diagram of the steps used in the preferred embodiment to carry out the function of the service discovery request handler of the universal data warehouse of the preferred embodiment.

FIG. 5A is a flow diagram of the steps used in the preferred embodiment to carry out the function of the service update processor of the purpose optimized device of the preferred embodiment.

FIG. 5B is a flow diagram of the steps used in the preferred embodiment to carry out the function of the service update handler of the universal data warehouse of the preferred embodiment.

FIG. 6 shows the message types, message format, and service update record used by the mechanisms of the preferred embodiment.

### DESCRIPTION OF THE PREFERRED EMBODIMENT

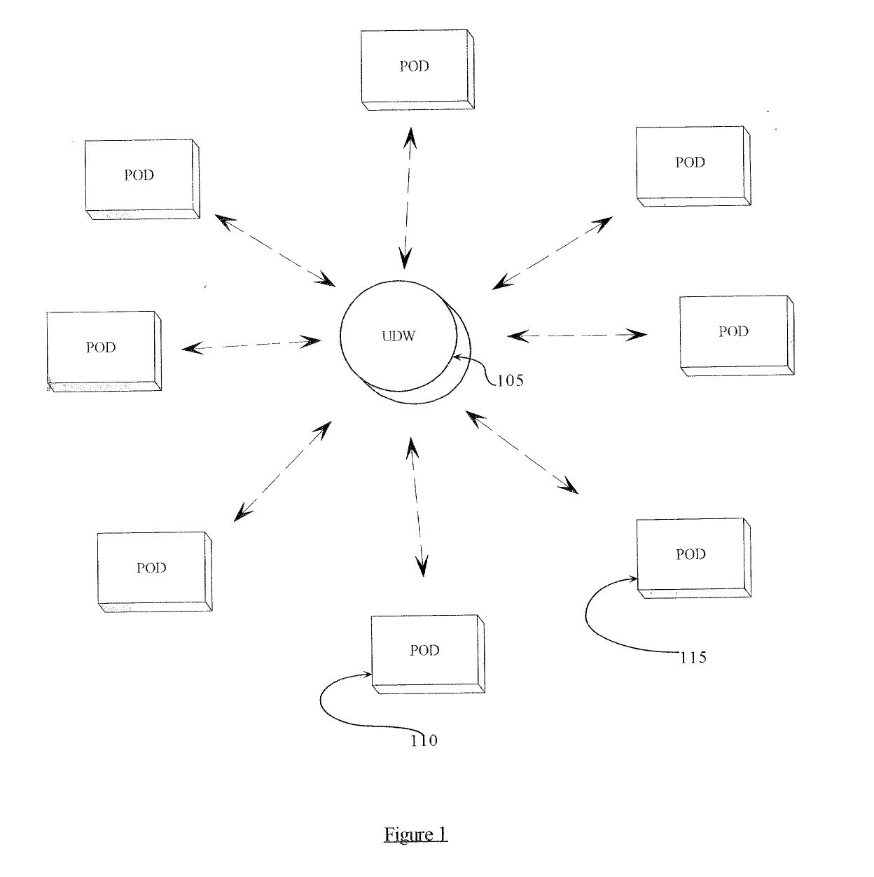

Turning now to the drawings, FIG. 1 is a block diagram of the wearable data network of the preferred embodiment. As shown, Wearable Data Network 100 of the preferred embodiment is comprised of UDW 105 and a plurality of PODs. As described above, UDW 105 is a personal data warehouse that is used in conjunction with one or more PODs to process the user's data. For example, if POD 110 were a audio POD, it would be used to play audio files from UDW 105. Sirmilarly, if POD 115 were a presentation POD, it would be used to render presentation files (e.g., Lotus Freelance files) stored on UDW 105. Wearable Data Network (WDN) 100 of the preferred embodiment is a wireless network that conforms with the Bluetooth standard, although those skilled in the art will appreciate that other standards for wireless communications could be used.

“System on a Chip” Components

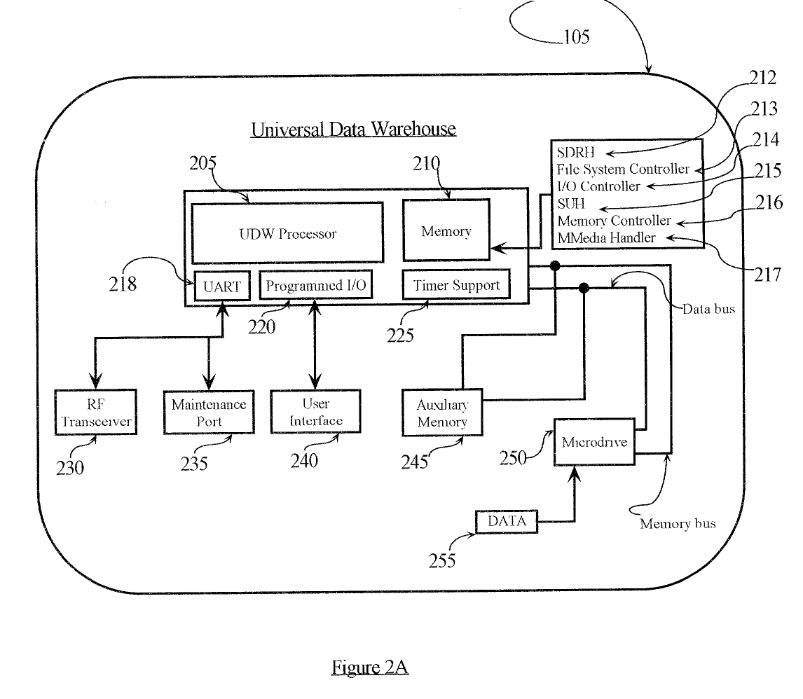

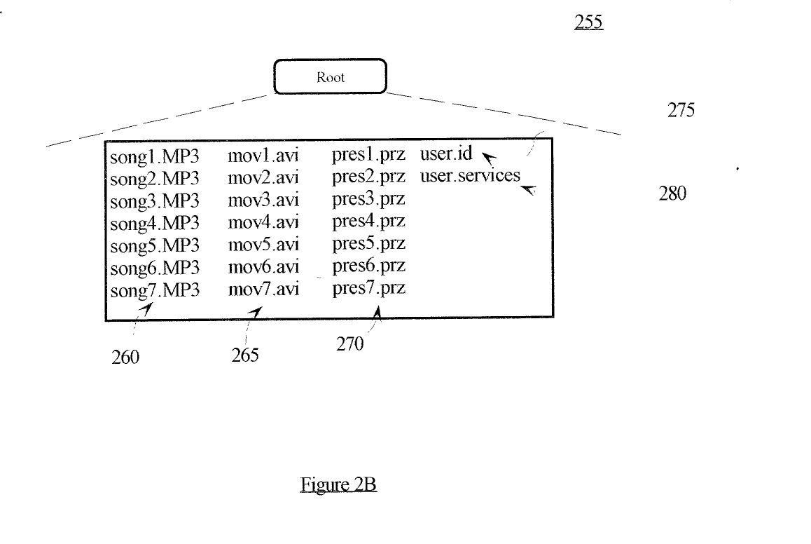

FIG. 2A is a block diagram showing the internals of UDW 105 of the preferred embodiment. As shown, the main processing unit of UDW 105 comprises UDW processor 205, memory 210, UART 218, programmed I/O control 220, and timer control 225. In the preferred embodiment, an X86, 14 Mhz., system on a chip from AMD® Corporation is used to provide these components/functions. However, those skilled in the art will appreciate that other similar component packages could be used. The processing unit of UDW 105 could also be built using individual components. UDW processor 205 is used to execute the programs stored in memory 210. UART 218 is used to transmit/receive information from RF Transceiver 230 and Maintenance Port 235, although it should be understood that other similar devices could be used. Programmed I/O controller 220 is used to interact with User Interface 240. Timer Support 225 is responsible for refresh control of Auxiliary Memory 245.

Interconnected Components

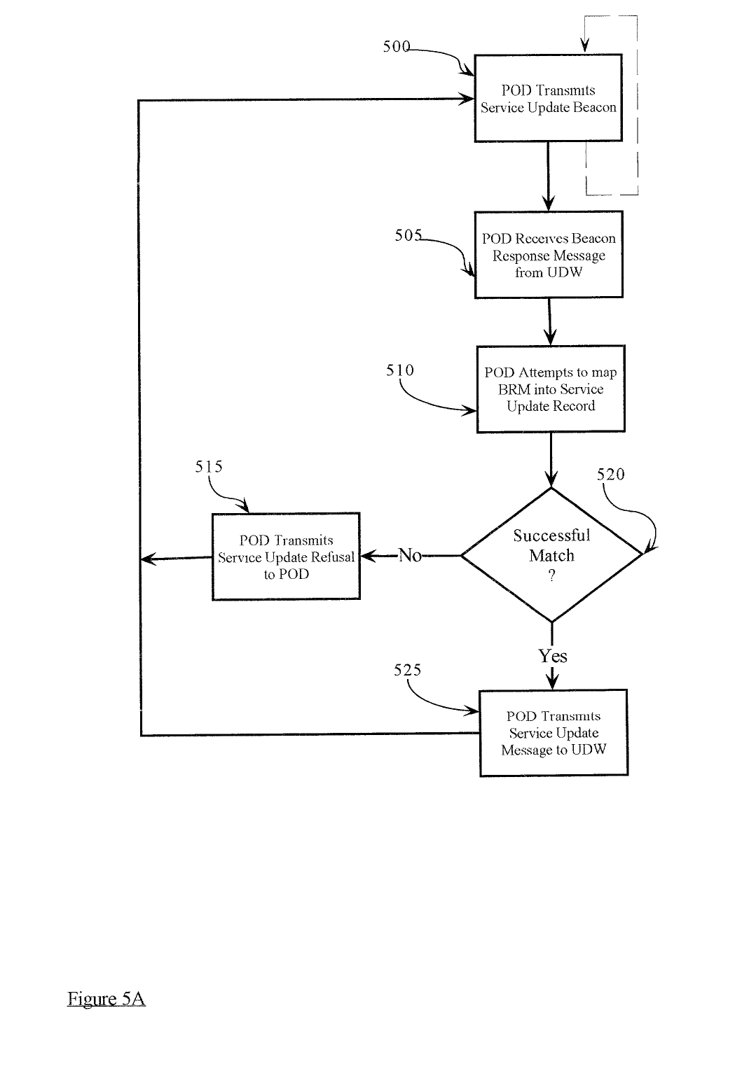

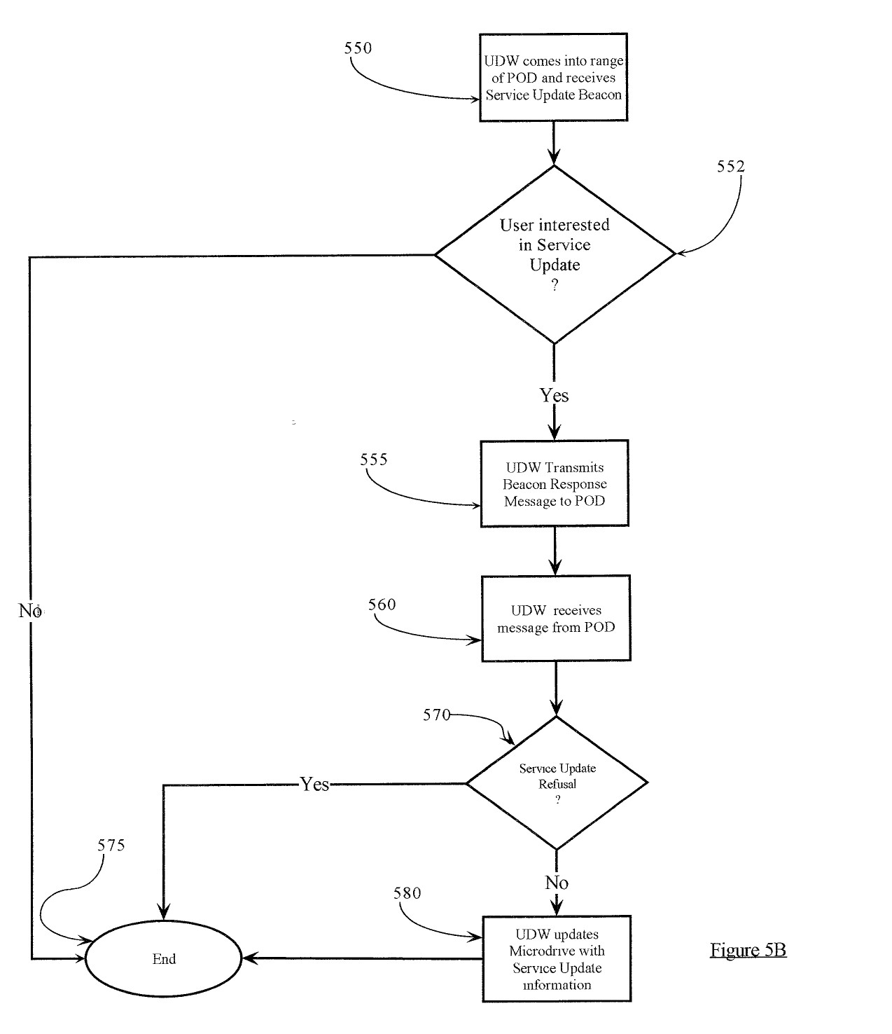

RF Transceiver 230 is used by UDW 105 to communicate with the other components of WDN 100 (i.e., the various PODs within WDN 100). RF transceiver 230 of the preferred embodiment is an Ericsson® Bluetooth RF transceiver, although other Bluetooth transceivers and non-Bluetooth transceivers could be used. Maintenance Port 235 is used for updating the software programs of UDW 105 and for debugging. Maintenance Port 235 is also used to configure UDW 105 with user ID and password information and specify service update types of interest to the user (see FIGS. 5A and 5B and the associated text). User ID and password information is stored in a user.id file (see user.id file 275 of FIG. 2B) and service update information is stored in a user.services file (see user.services file 280 of FIG. 2B). User Interface 240 of the preferred embodiment is a push button for manual activation of maintenance port 235. Auxiliary memory 245 is used for data caching, data buffering between memory 210 and Microdrive 250, and for code storage. As shown, Microdrive 250 is used to store Data 255. Microdrive 250 is an IBM® 1 G Microdrive, but other compact storage devices could be used.

Software Programs

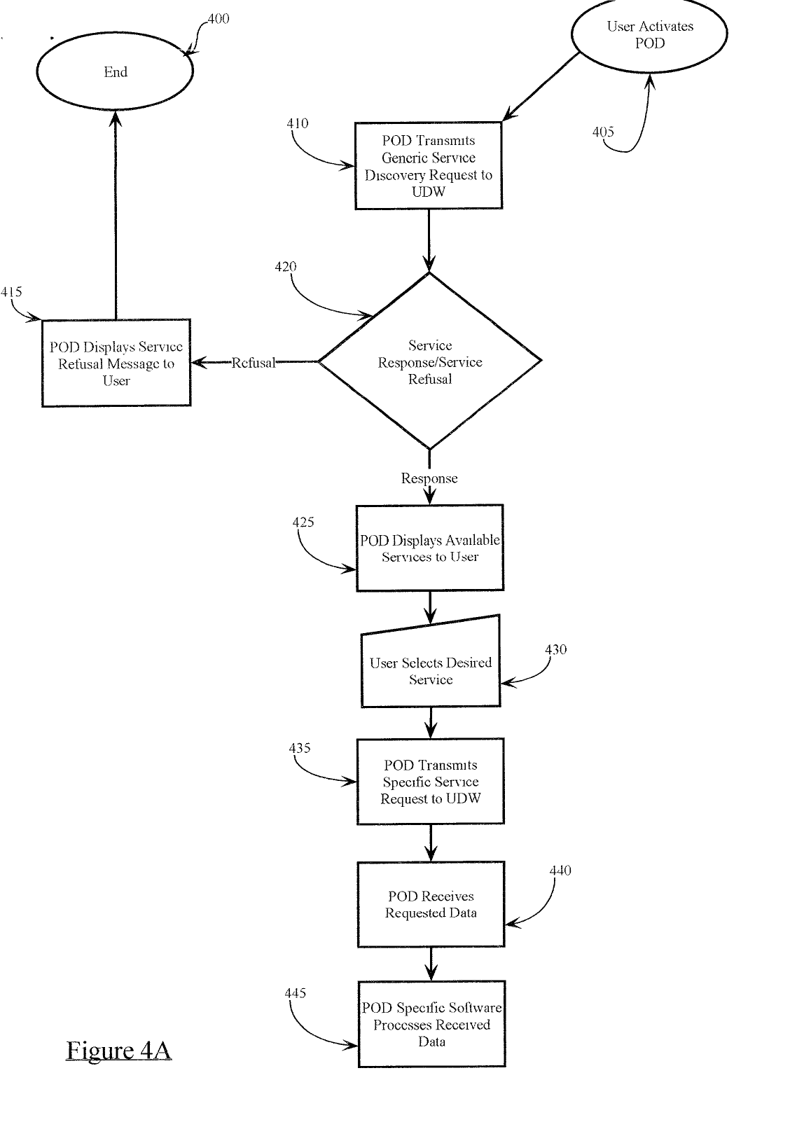

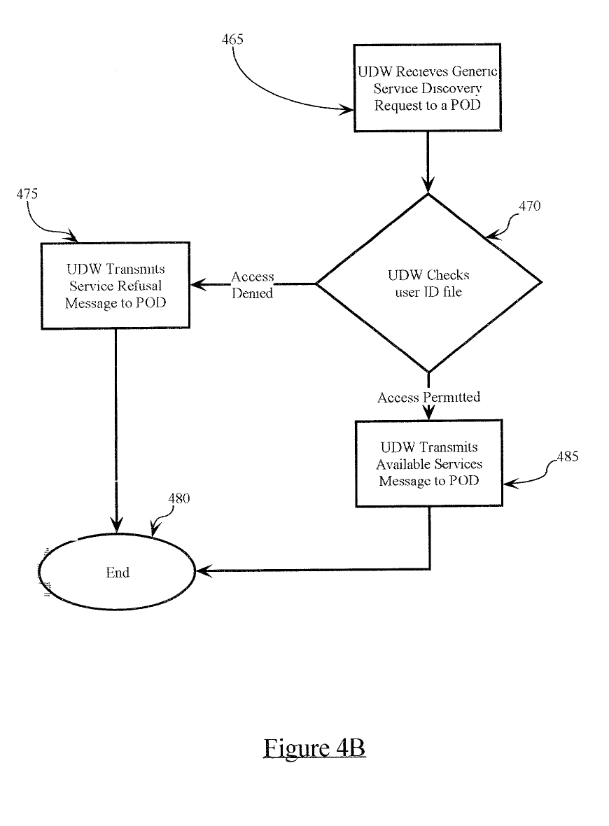

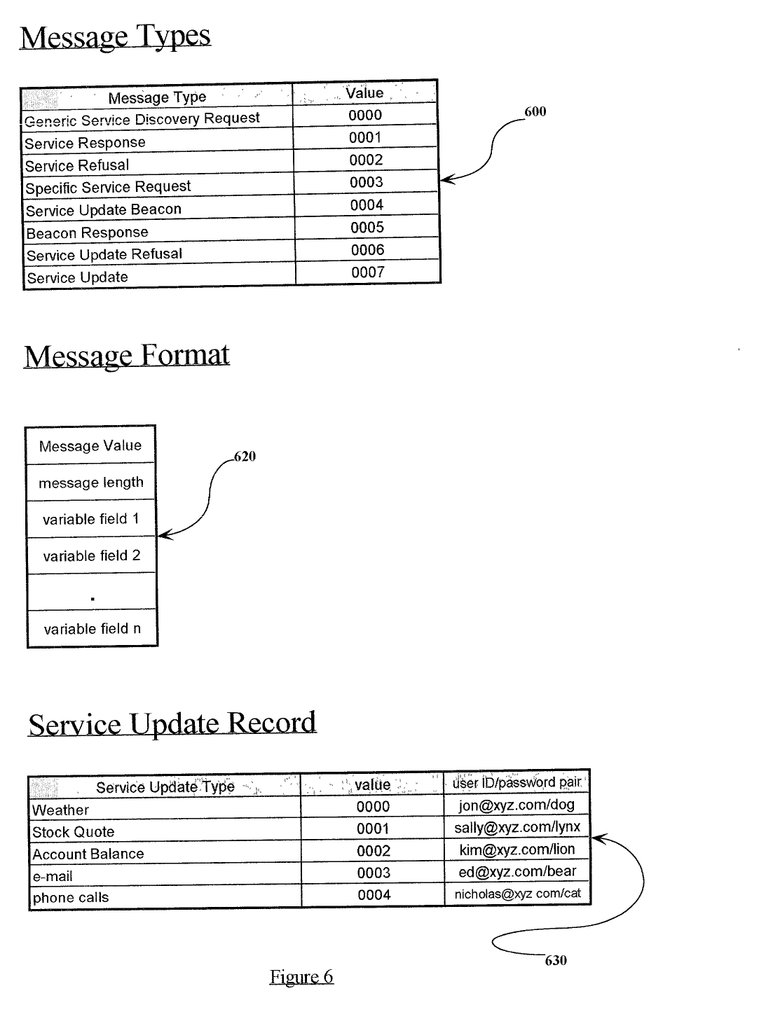

As shown, there are various programs depicted as being contained within memory 210. It should be understood that these programs have been shown in this manner to facilitate explanation of the preferred embodiment of the present invention. In reality these programs (or portions thereof) are only present in non-persistent memory 210 when executing on UDW processor 205. At other times, these programs will be stored in Auxiliary Memory 245 or potentially within Microdrive 250. With that said, SDRH (Service Discovery Request Handler) 212 is used within the preferred embodiment to receive and handle Service Discovery Request messages from the PODs of WDN 100. SDRH 212 is explained in more detail in the text associated with FIGS. 4A, 4B, and 6. File System Controller 214 is used to maintain the file system of Microdrive 250. This file system is shown on FIG. 2B and explained in the associated text.

I/O Controller 214 is a Bluetooth conforming driver that is used by other programs to interact with RF Transceiver 230. SUH (Service Update Handler) 215 is used to receive and handle Service Update Messages from the PODs of WDN 100. SUH 215 is explained in more detail in the text associated with FIGS. 5A, 5B, and 6. Memory Controller 216 is an internal mechanism that is used to handle the movement, including caching and buffering, of data and code amongst the memory device (i.e., memory 210, Auxiliary Memory 245, and Microdrive 250) of UDW 105. Mmedia Handler 217 is a multimedia streaming driver. The multimedia protocol of the preferred embodiment is proprietary, although those skilled in the art will appreciate that any isochronous protocol, such as that known in the industry as Shockwave, could be used.

FIG. 2B is a block diagram of the file system structure used in the preferred embodiment for Microdrive 250 of UDW 105. As shown, the file system includes a root directory in which there are stored a plurality of files of different types. MP3 files 260 are audio files, avi files 265 are video files, and prz files 270 are presentation files (i.e., Lotus 5 Freelance files). Those skilled in the art will appreciate that neither preferred embodiment nor the present invention are limited to these particular file types. User.id file 275, which is explained in more detail in the text associated with FIG. 4B, is used for security control.

“System on a Chip” Components

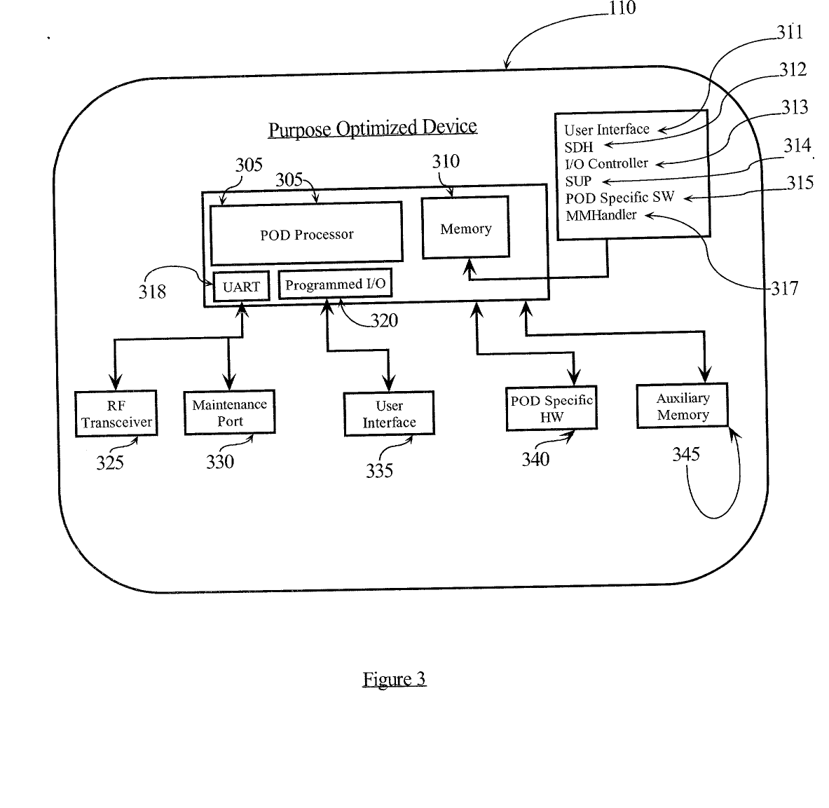

FIG. 3 is a block diagram showing the internals of POD 110 of the preferred embodiment. As shown, the main processing unit of POD 110 comprises POD processor 305, memory 310, UART 318, and programmed I/O control 320. In the preferred embodiment, an X86, 14 Mhz., system on a chip from AMD® Corporation is used to provide these components/functions. However, as described above with respect to UDW 105, those skilled in the art will appreciate that other similar component packages could be used. The processing unit of POD 110 could also be built using individual components. POD processor 305 is used to execute the programs stored in memory 310. UART 318 is used to transmit/receive information from RF Transceiver 325 and Maintenance Port 330. Programmed I/O controller 320 is used to interact with User Interface 335.

Interconnected Components

RF Transceiver 325 is used by POD 110 to communicate with the other components of WDN 100 (i.e., the various UDWs within WDN 100). RF transceiver 325 of the preferred embodiment is an Ericsson® Bluetooth RF transceiver, although other Bluetooth transceivers could be used. Maintenance Port 330 is used for is used for updating the software programs of POD 110 and for debugging. User Interface 335 of the preferred embodiment is a small LCD display. The display is used to convey various status messages to the user of POD 110. POD Specific Hardware 340 is used in this as a place holder for specific hardware that may be necessary to perform the function specific to a particular POD. For example, a presentation POD would include the specialized hardware necessary to visually render presentations as images on a movie screen. Auxiliary memory 345 is used for code storage.

Software Programs

As shown, there are various programs depicted as being contained within memory 310. As stated above in the discussion of UDW 105, it should be understood that these programs have been shown in this manner to facilitate explanation of the preferred embodiment of the present invention. In reality these programs (or portions thereof) are only present in non-persistent memory 310 when executing on UDW processor 305. At other times, these programs will be stored in Auxiliary Memory 345. With that said, User Interface control 311 is used in the preferred embodiment to allow other programs of POD 110 to interact with User Interface 335. SDH (Service Discovery Handler) 312 is used within the preferred embodiment to transmit Service Discovery Request messages and handle Service Response messages to/from the UDWs of WDN 100. SDH 312 is explained in more detail in the text associated with FIGS. 4A, 4B, and 6.

I/O Controller 313 is a Bluetooth conforming driver that is used by other programs to interact with RF Transceiver 230. SUP (Service Update Processor) 314 is used to transmit Service Update messages and to receive Service Update Response messages to/from the UDWs of WDN 100. SUP 215 is explained in more detail in the text associated with FIGS. 5A, 5B, and 6. MMedia Handler 317 is a multimedia streaming driver. As described above, the multimedia protocol of the preferred embodiment is proprietary, although other isochronous protocols could be used. It should also be understood that MMedia Handler 317 need be present only in PODs which depend on streamed data. A presentation POD, for example, would not require MM Handler 317 because presentation files would be transmitted into the presentation POD in their entirety before the presentation was rendered to the user.

It is important to note that while the present invention has been (and will continue to be) described in the context of a network and associated devices, those skilled in the art will appreciate that the certain mechanisms of the present invention are capable of being distributed as a program product in a variety of forms, and that the present invention applies equally regardless of the particular type of signal bearing media used to actually carry out the distribution. Examples of signal bearing media include: recordable type media such as floppy disks and CD ROMs and transmission type media such as digital and analogue communications links.

Bluetooth Protocol

As mentioned, the preferred embodiment of the present invention uses the industry standard Bluetooth protocol for wireless communications. It should be noted that implied in the ensuing discussion is the use of certain Bluetooth mechanisms to establish, conduct, and tear down connections made by the devices that make up WDN 100. Said another way, the service discovery and service update protocols described below execute in reliance of the Bluetooth protocol. Specifics of the use of the underlying Bluetooth protocol are well known in the art, and accordingly, are not included herein.

Service Discovery Processing

FIG. 4A is a flow diagram of the steps used in the preferred embodiment to carry out the function of the service discovery handler of the purpose optimized device of the preferred embodiment. After the user activates POD 110 in block 405, SDH 312 of POD 110 automatically transmits a Generic Service Discovery Request message [block 410]. FIG. 6 shows Message Type table 600 and Message Format 620. A Generic Service Discovery Request has a message value of 0000 and it includes a user ID/password pair, which are contained in the first two variable fields (see Message Format 620 of FIG. 6). This type of message has a message length of four (i.e., one for the message value, one for the message length value itself, and two for the user ID/password pair). (The exact mechanism used to store, maintain, and utilize user ID and password information is implementation dependent, and accordingly, it is not described herein. Those skilled in the art will appreciate that the specifics of the exact mechanism used are not important to the benefits and advantages of the present invention. It should also be understood that the user ID/password security protocol may not be wholly applicable in all situations and certain situations may require the use of more sophisticated security protocols such as PKCS or DES.) A Generic Service Discovery message is used in the preferred embodiment to query a UDW to determine what types of data (i.e., services) are present on the UDW.

After transmitting a Generic Service Discovery message, SDH 312 waits for UDW 105 to return a Service Response message or a Service Refusal message. Referring again to FIG. 6, a Service Response message has a message value of 0001 and a message length equal to the number of available services on the UDW at issue. Taking UDW 105 as an example, FIG. 2B shows that UDW 105 contains three different types of files (.MP3, .avi, and .prz), meaning that the message length field would be five (i.e., one for the message value, one for the message length, and three for each of the available services). Lastly, variable fields 1-3 would each contain a file type, one for each of the file types available on UDW 105. The Service Refusal message is another two word message containing only the message value (0002), and the message length (two).

If SDH 312 receives a Service Refusal message [block 420], SDH 312 displays a Service Refusal message to the user via user interface 335 [block 415] and terminates processing in block 400. (Note here that SDH 312 could alternatively be designed to repeatedly send Generic Service Discovery messages until a Service Response message was received.) If SDH 312 receives a Service Response message, SDH 312 displays the available services to the user, again via user interface 335 [block 425]. SDH 312 then waits for the user to select a particular service, which is received in block 430. SDH 312 then transmits a Specific Service Request in block 435. As its name suggests, a Specific Service Request is used in the preferred embodiment to specify the particular service that is desired by the user. The message value for this message is 0003 and the message length is two. After the Specific Service Request is transmitted, SDH 312 waits for the UDW to return the requested data. The data is received in block 440. After the data is received, SDH 445 passes the received data off to MMedia Handler 317 and POD specific software 315 for processing. By way of example, if the user selected audio service (i.e., .MP3 files), MMedia Handler 317 is used to stream the .MP3 files to POD specific software 315, which would be .MP3 player software.

FIG. 4B is a flow diagram of the steps used in the preferred embodiment to carry out the function of the service discovery request handler of the universal data warehouse of the preferred embodiment. SDRH 212 is the counterpart within UDW 105 of SDH 312 of POD 110. When SDH 312 transmits a Generic Service Discovery Request, it is received by SDRH 212 in block 465 of FIG. 4B. SDH 312 then accesses Microdrive 530 via File System Controller 213 and checks the user ID/password pair against the user ID/password pairs contained in user.id file 275 of Microdrive 530. (See user.id file 275 shown on FIG. 2B.) If the transmitted user ID/password pair is not present within user.id file 275, SDH 312 transmits a Service Refusal message [block 475] and terminates execution in block 480. If the transmitted user ID/password pair is present within user.id file 275, SDH 312 accesses Microdrive 530 via File System Controller 213, collects the different file types (i.e., services), creates a Service Response message, transmits the message to the requesting POD [block 485], and terminates execution in block 480.

Service Update Processing

FIG. 5A is a flow diagram of the steps used in the preferred embodiment to carry out the function of the service update processor of the purpose optimized device of the preferred embodiment. In block 500, SUP (service update processor) 314 of the preferred embodiment repeatedly transmits a Service Update Beacon message. This particular message is used within WDN 100 to inform one or more UDWs that a POD has service update information available. Note here that for security reasons, the message does not include the information itself, only an indication that information of a particular type is available. As with the above-described messages, the Service Update Beacon message is shown on FIG. 6. The Service Update Beacon message has a message value of 0004, a message length value that depends on the number of services at issue, and one or more variable fields to accommodate the encodings of the different service types. For example, if POD 110 was optimized to deliver service update information and had weather and e-mail information as available services, SUP 314 would transmit a Service Update Beacon that had a message length of four (i.e., one for the message value, one for the message length, and two for the available services. Referring to Service Update Record 630, a weather service has an encoding of 0000 and an e-mail service has an encoding of 003. The particular way in which a POD is updated with service information is particular to a given POD, meaning that different types of PODs will gain access to service update information in different ways. It should also be noted that the particular way in which PODs are updated with service information is not important to the benefits and advantages of the preferred embodiment of the present invention. Accordingly, information regarding how a given POD type is updated is not included herein.

A UDW will respond to a Service Update Beacon message when it is in range and its user is interested in receiving service updates of the type transmitted in the beacon. SUP 314 receives Beacon Response messages in processing block 505. Beacon Response messages include an indication of the type of service requested and an ID/password pair. SUP 314 attempts to map this information into the Service Update Record (see FIG. 6) [block 510]. In performing this mapping, SUP 314 will determine whether there is a matching entry in the Service Update Record and the information transmitted in the Beacon Response message. For example, if UDW 105 were to respond to a Service Update Beacon message with a Beacon Response message that included a Service Update type of 0004 (“phone calls”) and an ID password pair of nicholas@xyz.com/cat, SUP 314 would find the match [block 520] and transmit the information to UDW 105 [block 525]. On the other hand if SUP 314 was unable to find a match within Service Update Record 630, SUP 314 would transmit a Service Update Refusal message to UDW 105.

FIG. 5B is a flow diagram of the steps used in the preferred embodiment to carry out the function of the service update handler of the universal data warehouse of the preferred embodiment. Service Update Handler 215 is the counterpart of UDW 105 to SUP 314 of POD 110. As stated above, when UDW 105 comes into range of POD 110, it receives a Service Update Beacon message [block 550]. UDW 105 then checks its services file (see user.services file 280 on FIG. 2B) to determine whether its user has indicated interest in one or more of the services specified in the Service Update Beacon message [block 552]. If the services file does include an indication of interest in one of the services contained in the Service Update Beacon message, UDW 105 responds by transmitting a Beacon Response message in block 555 to POD 110. As stated above, the Beacon Response message includes the requested service update types and an ID/password pair. UDW 105 then receives a message from POD 110 [block 560] and determines whether the message is a Service Refusal message [block 570]. If the message is not a Service Refusal message, UDW 105 updates Microdrive 530 to include the updated services [block 580] and then terminates execution in block 575. If the message is a Service Refusal message, UDW 105 simply terminates execution in block 575.

Bulk Service Update

When the user wishes to load a large amount of data on UDW 105 (e.g., several audio or video files), the user simply removes Microdrive 530 from UDW 105 and connects it to a computer system using the compact flash interface of Microdrive 530. The user is then able to manually manipulate (add, remove, or change) files on Microdrive 530.

The embodiments and examples set forth herein were presented in order to best explain the present invention and its practical application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A data storage network, said network comprising:
a portable data storage device, said portable data storage device storing data, said data being a first type of data, said data storage device being incapable of processing said data; and
a purpose optimized device, said purpose optimized device being optimized to perform a specific task, said specific task being processing said data of said first type, said purpose optimized device being wirelessly connected to said portable storage device to perform said specific processing task.

2. The data storage network of claim 1 wherein said portable data storage device also stores data of a second type and wherein said purpose optimized device is incapable of processing data of said first type.

3. The data storage network of claim 2 wherein said data storage network further comprises a second purpose optimized device, said second purpose optimized device being optimized to perform a second specific task, said second specific task being processing said data of said second type.
